(19) United States
(12) Patent Application Publication
(10) Pub. No.: US 2025/0316270 A1
(43) Pub. Date: Oct. 9, 2025

(54) METHOD AND APPARATUS FOR GENERATING VIDEO SCRIPT

(71) Applicant: BEIJING BAIDU NETCOM SCIENCE TECHNOLOGY CO., LTD., Beijing (CN)

(72) Inventor: Xiangyang Wang, Beijing (CN)

(73) Assignee: BEIJING BAIDU NETCOM SCIENCE TECHNOLOGY CO., LTD., Beijing (CN)

(21) Appl. No.: 19/246,317

(22) Filed: Jun. 23, 2025

(30) Foreign Application Priority Data
Apr. 18, 2025 (CN) 202510496117.1

(51) Int. Cl. G10L 15/26; G06V 40/20

(52) U.S. Cl. CPC G10L 15/26; G06V 40/23

(57) ABSTRACT

A method for generating a video script, including: obtaining a target video; obtaining dialogue text information by performing speech recognition on speech segments in the target video; extracting a human body feature of a speaker from an frame associated with the speech segments in the target video, and extracting a voiceprint feature of the speaker from the speech segments; determining target feature information matching at least one of the human body feature of the speaker or the voiceprint feature of the speaker from a character library corresponding to the target video, and determining a target character corresponding to the target feature information in the character library; and generating the video script for the target video based on the target character and the dialogue text information.

### CROSS-REFERENCE TO RELATED APPLICATION

The present application is based upon and claims priority to Chinese Patent Application No. 2025104961171, filed on Apr. 18, 2025, the entirety contents of which are incorporated herein by reference.

### TECHNICAL FIELD

The disclosure relates to the field of artificial intelligence (AI), specifically to technologies such as artificial intelligence, big data, and deep learning, and in particular to a method and an apparatus for generating a video script.

### BACKGROUND

With explosive growth in short video production, a video script plays a crucial auxiliary role in practical workflows, both for in-depth analysis and understanding of a produced video, and for the subsequent generation of highlight content. Given diverse and complex nature of video content, information about characters appearing in a video typically forms core content of the script.

Thus, how to generate a video script becomes particularly important.

### SUMMARY

The disclosure provides a method for generating a video script.

According to an aspect of the disclosure, a method for generating a video script is provided. The method includes: obtaining a target video; obtaining dialogue text information by performing speech recognition on speech segments in the target video; extracting a human body feature of a speaker from a frame associated with the speech segments in the target video, and extracting a voiceprint feature of the speaker from the speech segments; determining target feature information matching at least one of the human body feature of the speaker or the voiceprint feature of the speaker from a character library corresponding to the target video, and determining a target character corresponding to the target feature information in the character library; and generating the video script for the target video based on the target character and the dialogue text information.

According to another aspect of the disclosure, an electronic device for generating a video script is provided. The electronic device includes: at least one processor; and a memory with read executable program codes stored thereon; in which the at least one processor is configured to perform the method for generating a video script according to the above aspect.

According to another aspect of the disclosure, a non-transitory computer readable storage medium is provided. The non-transitory computer readable storage medium stores computer instructions, in which the computer instructions are caused to enable a computer to perform the method for generating a video script according to the above aspect.

### BRIEF DESCRIPTION OF THE DRAWINGS

The accompanying drawings are used for a better understanding of the disclosure and do not constitute a limitation of the disclosure.

FIG. 1 is a schematic flowchart illustrating a method for generating a video script according to an embodiment 1 of the disclosure.

FIG. 2 is a schematic flowchart illustrating a method for generating a video script according to an embodiment 2 of the disclosure.

FIG. 3 is a schematic flowchart illustrating a method for generating a video script according to an embodiment 3 of the disclosure.

FIG. 4 is a schematic flowchart illustrating a method for generating a video script according to an embodiment 4 of the disclosure.

FIG. 5 is a schematic flowchart illustrating a method for generating a video script according to an embodiment 5 of the disclosure.

FIG. 6 is a block diagram illustrating an apparatus for generating a video script according to an embodiment 6 of the disclosure.

FIG. 7 is a block diagram illustrating an example electronic device that is configured to implement embodiments of the disclosure.

### DETAILED DESCRIPTION

Illustrative embodiments of the disclosure are described hereinafter in conjunction with the accompanying drawings, which include various details of the embodiments of the disclosure in order to aid in understanding, and should be considered illustrative only. Accordingly, those of ordinary skill in the art should realize that various changes and modifications can be made to the embodiments described herein without departing from the scope and spirit of the disclosure. Similarly, descriptions of well-known features and structures are omitted from the following description for the sake of clarity and brevity.

In general, video content is diverse and complex. A plurality of characters may appear in a video, and different characters may appear at different timestamps in the video. Even a same character may appear in different segments of the video. Segments where characters appear constitute important content of the video. Dialogue text information expressed by the characters is also crucial information for understanding the video. To enable a generated script to accurately reflect the core content of the video, how to generate a video script is highly important.

In related art, the following manners are typically adopted to generate a video script:

The first manner, when generating a video script, does not focus on characters portrayed by speakers and introduction information of the characters during a process of recognizing speakers who express dialogue text information via speech in the video.

The second manner, when recognizing the characters in the video, identifies the characters solely based on a human body feature, or solely based on a voiceprint feature.

It should be noted that generating a video script using the above manners presents at least the following problems.

For the first manner, omitting information about the characters portrayed by the speakers causes the generated script to lack character introduction content, which may prevent the generated script from fully summarizing all core content of the video.

For the second manner, identifying speakers in the video solely based on the human body feature or solely based on the voiceprint feature is problematic. A plurality of characters may appear in a video, and both the human body feature and the voiceprint feature are important features for a character. Thus, failing to comprehensively consider both the human body feature and the voiceprint feature may adversely affect the recognition effect on the characters.

To facilitate understanding, relevant concepts potentially involved in the embodiments of the disclosure are briefly explained first.

Artificial Intelligence (AI) is an important driving force for a new round of technological revolution and industrial transformation. It is a new technological science that studies and develops theories, methods, technologies, and application systems for simulating, extending, and expanding human intelligence.

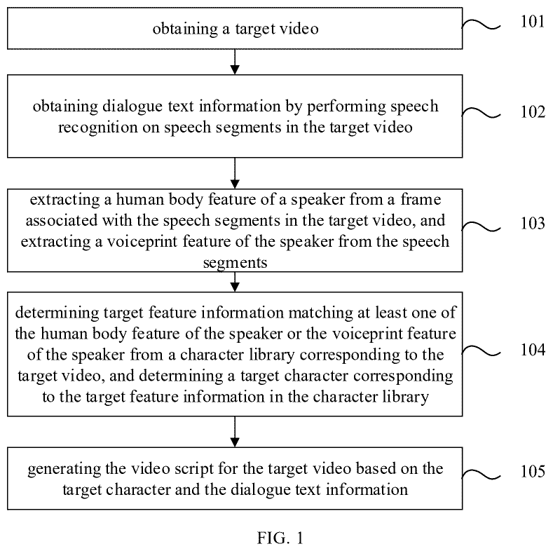

FIG. 1 is a schematic flowchart illustrating a method for generating a video script according to an embodiment 1 of the disclosure. As shown in FIG. 1, the method includes the following steps 101 to 105.

Embodiments of the disclosure are illustrated with the method for generating a video script being configured in an apparatus for generating a video script. The apparatus for generating a video script may be applied to any electronic device to enable the electronic device to perform the function of generating a video script.

The electronic device may be any device with computing capabilities, such as a personal computer (PC), a mobile terminal, a server, etc. The mobile terminal can be, for example, a smartphone, a tablet, a personal digital assistant, a wearable device, or other hardware devices with various operating systems, touch screens, and/or displays. At step 101, a target video is obtained.

It may be understood that the target video includes speech segments and silent segments.

It should be understood that in practical application scenarios, the target video typically don't contain continuous speech throughout. To ensure that the content presented by the produced target video is logical and interesting, the target video may have segmented speech segments. The silent segments may also exist between different speech segments. Further, characters who produce dialogue text via speech exist within the speech segments and constitute core information of the content presented by the target video. Thus, focusing on the speech segments of the target video is crucial for generating the video script.

At step 102: corresponding dialogue text information is obtained by performing speech recognition on the speech segments in the target video.

It should be noted that different speech segments may include different numbers of characters and characters outputting different dialogue text via speech. Thus, the corresponding dialogue text information obtained from different speech segments is also different.

At step 103: a human body feature of a speaker is extracted from a frame associated with the speech segments in the target video, and a voiceprint feature of the speaker is extracted from the speech segments.

It may be understood that the speaker refers to a character who producing the dialogue text via speech in the speech segment.

It should be understood that performing image feature extraction on the frame associated with the speech segments in the target video may extract a plurality of human body features. However, not all the characters appearing in the target video necessarily produce the dialogue text. Thus, not all extracted human body features belong to the speaker. Furthermore, although performing voiceprint extraction on the speech segment may determine extracted voiceprint features originating from speakers within the speech segment, there may be a plurality of speakers within the speech segment. Thus, further analysis of the extracted voiceprint features is required.

For example, performing the image feature extraction on the frame associated with the speech segment in the target video extracts a plurality of human body features. The plurality of human body features are clustered, and it is assumed that three human body features are determined: a human body feature A, a human body feature B, and a human body feature C. The voiceprint extraction is performed on the speech segment, and it is assumed that two voiceprint features are extracted: a voiceprint feature A and a voiceprint feature B. In this case, there is a correspondence between the human body feature A and the voiceprint feature A, both originating from a same person. There is a correspondence between the human body feature B and the voiceprint feature B, both originating from the same person. Thus, the speech segment contains a speaker A and a speaker B. A human body feature of the speaker A is the human body feature A, and a voiceprint feature of the speaker A is the voiceprint feature A. A human body feature of the speaker B is the human body feature B, and a voiceprint feature of the speaker B is the voiceprint feature B.

At step 104: target feature information matching at least one of the human body feature of the speaker or the voiceprint feature of the speaker is determined from a character library corresponding to the target video, and a target character corresponding to the target feature information in the character library is determined.

It should be noted that the character library includes feature information corresponding to each character.

For example, the character library includes character A, character B, and character C. Assuming the human body feature A of the speaker A and the voiceprint feature A of the speaker A are determined, and if the human body feature A matches feature information A corresponding to the character A, then the feature information A may be determined as the target feature information, and the target character (character A) corresponding to the target feature information (feature information A) in the character library is determined.

At step 105: the video script for the target video is generated based on the target character and the dialogue text information.

It should be understood that the target video may have a plurality of speech segments. The determined target character and the determined dialogue text information are derived from one speech segment in the target video. Target characters and the dialogue text information determined for different speech segments are different. Furthermore, the correspondence between the target character and the dialogue text information within a same speech segment may be diverse. Thus, to quickly generate the video script for the target video, the target video may be analyzed segment by segment based on the speech segments. The correspondence between the target character and each sentence of the dialogue text within the dialogue text information in a same speech segment is determined. Then, the video script for any speech segment is determined, thus generating the video script for the target video.

In summary, in the method for generating a video script provided by the disclosure, a target video is obtained, and corresponding dialogue text information is obtained by performing speech recognition on the speech segments in the target video. A human body feature of a speaker is extracted from a frame associated with the speech segments in the target video, and a voiceprint feature of the speaker is extracted from the speech segments. The target feature information matching at least one of the human body feature of the speaker or the voiceprint feature of the speaker is determined from the character library corresponding to the target video, and the target character corresponding to the target feature information in the character library is determined; and the video script for the target video is generated based on the target character and the dialogue text information. Thus, by performing the image feature extraction on each frame of the target video, not only the human body feature of the speaker is considered, but also the voiceprint feature of the speaker is considered. Both the human body feature and the voiceprint feature are comprehensively used to identify the target character appearing in the video from the character library, facilitating accurate identification of characters appearing in the video. Furthermore, during the process of generating the script, starting from the perspective of the target character in the video, focusing on the dialogue text information produced by the target character enables the generated video script to accurately reflect the content of the video, helps deepen the understanding of the video, and thus facilitates various subsequent applications based on the generated video script.

It should be noted that in the technical solutions of the disclosure, processing including collection, storage, use, shaping, transmission, provision and disclosure of the personal information of the user is performed with the consent of the user, and is in compliance with the provisions of relevant laws and regulations, and does not violate public order and good morals.

To illustrate how the human body feature of the speaker is extracted from the frame associated with the speech segment in the target video and how the voiceprint feature of the speaker is extracted from the speech segment in the embodiments of the disclosure, the disclosure also provides a method for generating a video script.

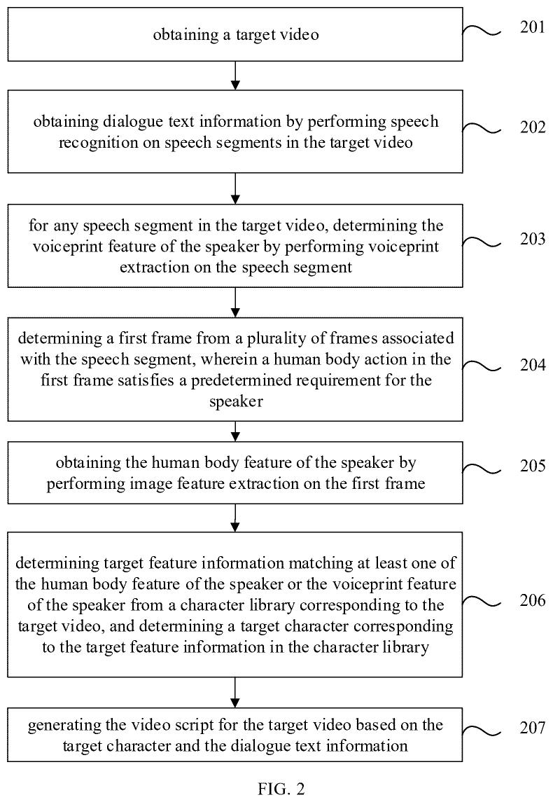

FIG. 2 is a schematic flowchart illustrating a method for generating a video script according to an embodiment 2 of the disclosure.

As shown in FIG. 2, the method for generating a video script may include the following steps 201 to 207.

At step 201, a target video is obtained.

At step 202: corresponding dialogue text information is obtained by performing speech recognition on speech segments in the target video.

Explanations for step 201 to step 202 may refer to relevant descriptions in the embodiments of the disclosure, which are not repeated herein.

At step 203: for any speech segment in the target video, a voiceprint feature of a speaker is determined by performing voiceprint extraction on the speech segment.

It should be noted that there is a one-to-one correspondence between the voiceprint feature extracted from the speech segment and the speaker. That is, the number of extracted voiceprint features is the same as the number of speakers.

For example, performing voiceprint extraction on the speech segment extracts two voiceprint features: voiceprint feature A and voiceprint feature B. Then, the speaker corresponding to the voiceprint feature A (speaker A) is not the same as the speaker corresponding to the voiceprint feature B (speaker B). There is a one-to-one correspondence between the voiceprint feature A and the speaker A, and there is a one-to-one correspondence between the voiceprint feature B and the speaker B.

At step 204: a first frame is determined from a plurality of frames associated with the speech segment, in which a human body action in the first frame satisfies a predetermined requirement for the speaker.

It should be noted that the predetermined requirement is determined based on an actual need. For example, the predetermined requirement may be set as a human body action where a facial action of a human body is mouth opening.

To accurately determine the first frame from the plurality of frames associated with the speech segment, as a possible implementation manner, the first frame satisfying the predetermined requirement is determined based on a human body action recognized within a human body region in any frame of the plurality of frames.

For example, frames synchronously displayed within the speech segment are determined as the plurality of frames associated with the speech segment; a human body region within each of the plurality of frames is obtained by performing object recognition thereon, and the human body action is obtained by performing action recognition on the human body region; the first frame satisfying the predetermined requirement is determined from the plurality of frames based on the human body action recognized in each frame.

At step 205: a human body feature of the speaker is obtained by performing image feature extraction on the first frame.

It should be understood that a plurality of human body regions may be contained within the human body region in the first frame, and not all of the plurality of human body regions originate from the speaker. Thus, it is necessary to further filter the plurality of human body regions within the first frame to determine the human body region where the speaker is located.

To accurately obtain the human body feature of the speaker, as a possible implementation manner, the human body feature of the speaker is determined based on a human body region within the first frame in which the human body action satisfies the predetermined requirement.

For example, the human body feature of the speaker is obtained by performing image feature extraction on a target human body region within the first frame, in which the target human body region is a human body region in which the human body action satisfies the predetermined requirement.

To perform the action recognition on the human body region and completely obtain the human body action within the human body region, as a possible implementation manner, the human body action is determined based on a positional relationship among a plurality of human body key points recognized within the human body region.

For example, human body key point recognition is performed on the human body region; the human body action is determined based on a positional relationship among a plurality of recognized human body key points.

At step 206: target feature information matching at least one of the human body feature of the speaker or the voiceprint feature of the speaker is determined from a character library corresponding to the target video, and a target character corresponding to the target feature information in the character library is determined.

At step 207: the video script for the target video is generated based on the target character and the dialogue text information.

Explanations for step 206 to step 207 may refer to relevant descriptions in the embodiments of the disclosure, which are not repeated herein.

In the method for generating a video script provided by the disclosure, for any speech segment in the target video, the voiceprint feature of the speaker is determined by performing the voiceprint extraction on the speech segment. The first frame is determined from the plurality of frames associated with the speech segment, in which the human body action in the first frame satisfies the predetermined requirement for the speaker. The human body feature of the speaker is obtained by performing the image feature extraction on the first frame. Thus, the voiceprint feature of the speaker is extracted first. The first frame where the speaker is located is determined step by step from the plurality of frames. Subsequently, the human body feature of the speaker is obtained based on the first frame where the speaker is located. By analyzing the plurality of frames step by step, it is ensured that the speaker may be accurately determined and the human body feature of the speaker may be extracted rapidly.

To illustrate how the target feature information matching at least one of the human body feature of the speaker and the voiceprint feature of the speaker is determined from the character library corresponding to the target video and how the target character corresponding to the target feature information in the character library is determined in the embodiments of the disclosure, the disclosure also provides a method for generating a video script.

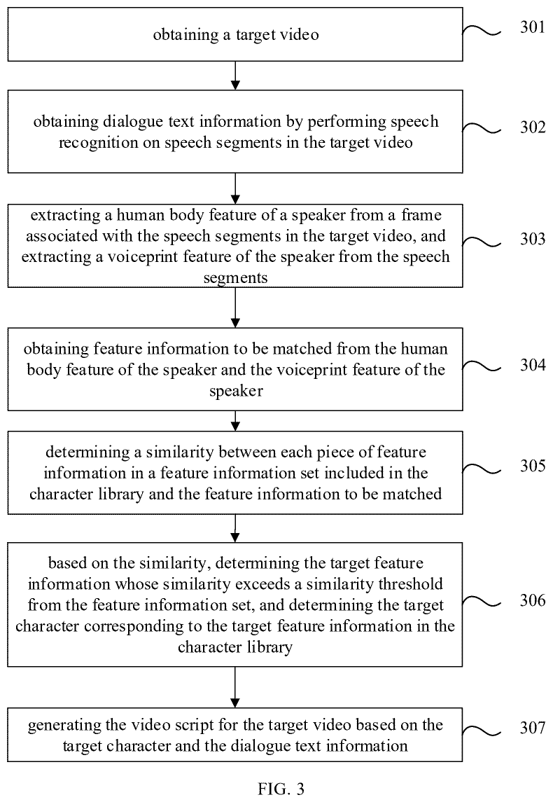

FIG. 3 is a schematic flowchart illustrating a method for generating a video script according to an embodiment 3 of the disclosure.

As shown in FIG. 3, the method for generating a video script may include the following steps 301 to 307.

At step 301, a target video is obtained.

At step 302: corresponding dialogue text information is obtained by performing speech recognition on speech segments in the target video.

At step 303: a human body feature of a speaker is extracted from a frame associated with the speech segments in the target video, and a voiceprint feature of the speaker is extracted from the speech segments.

Explanations for step 301 to step 303 may refer to relevant descriptions in the embodiments of the disclosure, which are not repeated herein.

At step 304: feature information to be matched is obtained from the human body feature of the speaker and the voiceprint feature of the speaker.

It should be noted that specific information of the feature information to be matched may be determined based on actual situations, which is not specifically limited in this embodiment. For example, the specific information of the feature information to be matched may be divided into three cases respectively: the feature information to be matched includes both the human body feature of the speaker and the voiceprint feature of the speaker; the feature information to be matched includes only the human body feature of the speaker; and the feature information to be matched includes only the voiceprint feature of the speaker.

At step 305: a similarity between each piece of feature information in a feature information set included in a character library and the feature information to be matched is determined.

It should be noted that the feature information set includes the feature information corresponding to each character in the character library.

At step 306: based on the similarity, the target feature information whose similarity exceeds a similarity threshold is determined from the feature information set, and the target character corresponding to the target feature information in the character library is determined.

It should be noted that a specific value of the similarity threshold may be determined based on actual situations, which is not specifically limited in this embodiment.

For example, the feature information set in the character library includes feature information A and feature information B. The feature information A corresponds to character A, and the feature information B corresponds to character B. Assuming the similarity between the feature information to be matched and the feature information A exceeds the similarity threshold. Then, the feature information A may be taken as the target feature information, and the target character (the character A) corresponding to the target feature information (feature information A) in the character library is determined.

At step 307: the video script for the target video is generated based on the target character and the dialogue text information.

Explanations for step 307 may refer to relevant descriptions in the embodiments of the disclosure, which are not repeated herein.

In the method for generating a video script provided by the disclosure, the feature information to be matched is obtained from the human body feature of the speaker and the voiceprint feature of the speaker. The similarity between each piece of feature information in the feature information set included in the character library and the feature information to be matched is determined. Based on the similarity, the target feature information whose similarity exceeds the similarity threshold is determined from the feature information set, and the target character corresponding to the target feature information in the character library is determined. Thus, by comprehensively considering the human body feature of the speaker and the voiceprint feature of the speaker, the target feature information matching the feature information to be matched is determined from the feature information set based on the similarity between each piece of feature information and the feature information to be matched. Consequently, the accuracy of obtaining the target character is improved. Furthermore, based on the similarity, the target feature information may be rapidly located among a plurality of pieces of feature information.

To illustrate how the video script for the target video is generated based on the target character and the dialogue text information in the embodiments of the disclosure, the disclosure also provides a method for generating a video script.

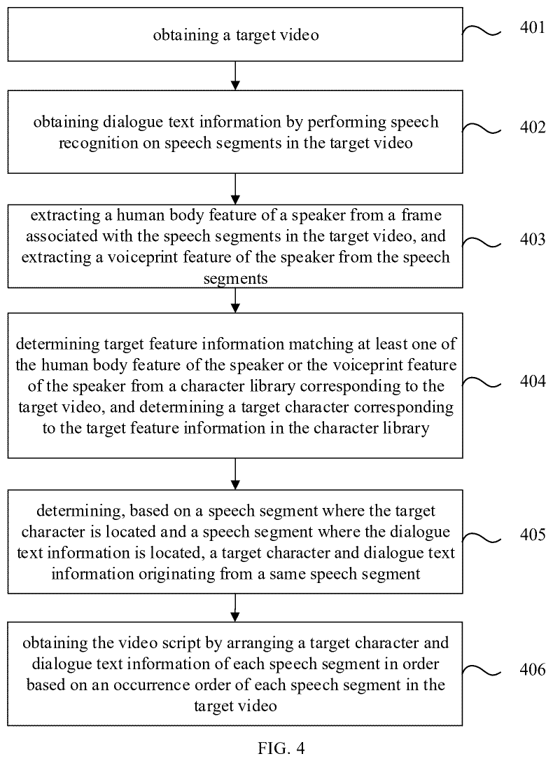

FIG. 4 is a schematic flowchart illustrating a method for generating a video script according to an embodiment 4 of the disclosure.

As shown in FIG. 4, the method for generating a video script may include the following steps 401 to 406.

At step 401, a target video is obtained.

At step 402: corresponding dialogue text information is obtained by performing speech recognition on speech segments in the target video.

At step 403: a human body feature of a speaker is extracted from an frame associated with the speech segments in the target video, and a voiceprint feature of the speaker is extracted from the speech segments.

At step 404: target feature information matching at least one of the human body feature of the speaker or the voiceprint feature of the speaker is determined from a character library corresponding to the target video, and a target character corresponding to the target feature information in the character library is determined.

Explanations for step 401 to step 404 may refer to relevant descriptions in the embodiments of the disclosure, which are not repeated herein.

At step 405: based on a speech segment where the target character is located and a speech segment where the dialogue text information is located, a target character and dialogue text information originating from a same speech segment are determined.

It should be understood that the target video further includes one or more silent segments. For the video script, scene-specific script content is also indispensable. Thus, to make the generated video script richer and capable of encompassing all important contents within the target video, in addition to focusing on the speech segments, background description information of the silent segment may also be extracted to form part of the video script.

To obtain a complete video script, as a possible implementation manner, in a case that the silent segment has a background switch relative to an adjacent speech segment, the background description information of the silent segment is inserted into the video script.

For example, the target video includes one silent segment, background recognition is performed on the silent segment and the adjacent speech segment for the silent segment; in a case that the silent segment has a background switch relative to the adjacent speech segment, the background description information of the silent segment is obtained by performing semantic recognition on a background of the silent segment; and based on an appearance order of the silent segment in the target video, the background description information is inserted into the video script.

For example, the target video includes two silent segments, background recognition is performed on the two silent segments and an adjacent speech segment between the two silent segments; in a case that at least one of the two silent segments has a background switch relative to the adjacent speech segment, background description information of the at least one of the two silent segments is obtained by performing the semantic recognition on a background of the at least one of the two silent segments; and based on an appearance order of the at least one of the two silent segments in the target video, the background description information is inserted into the video script.

At step 406: based on an appearance order of each speech segment in the target video, the video script is obtained by arranging a target character and dialogue text information of each speech segment in order.

It should be understood that the dialogue text information described by the target character is the core content of the video script. However, introduction text information of the target character also helps deepen the understanding of the target character appearing in the target video. Thus, during the process of generating the video script, the introduction text information of the target character may be associated with the dialogue text information, facilitating an intuitive understanding in the subsequently generated video script of exactly which target character corresponds to which specific dialogue text.

To obtain a more complete video script, as a possible implementation manner, the introduction text information corresponding to the target character is supplemented to the video script based on the character library.

For example, the introduction text information corresponding to the target character is obtained by querying the character library based on the target character, in which the character library includes introduction text information corresponding to each character; and based on a position of the dialogue text information of the target character in the video script, the introduction text information is supplemented to the video script.

In the method for generating a video script provided by the disclosure, based on the speech segment where the target character is located and the speech segment where the dialogue text information is located, the target character and the dialogue text information originating from the same speech segment are determined, and based on the appearance order of each speech segment in the target video, the video script is obtained by arranging the target character and the dialogue text information of each speech segment in order. Thus, the target character and the dialogue text information of each speech segment are arranged based on the appearance order of each speech segment in the target video to form the video script. This method prioritizes the core content of the script, facilitating the generation of a more complete video script, enabling the generated video script to deeply reflect the content of the target video.

To illustrate how the character library is generated in the embodiments of the disclosure, the disclosure also provides a method for generating a video script.

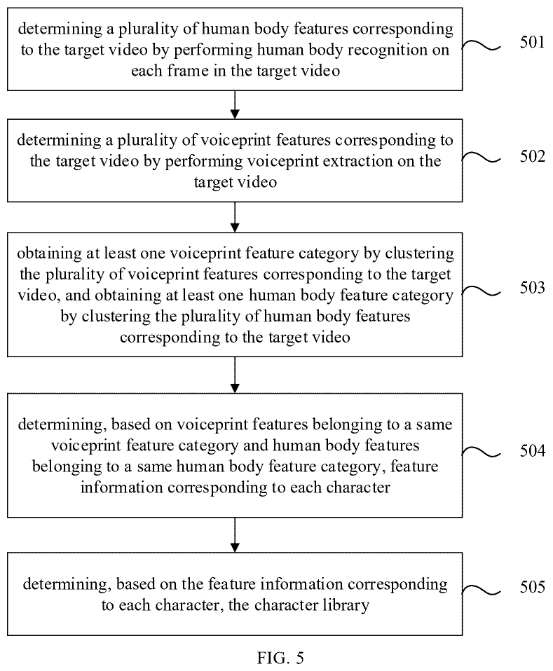

FIG. 5 is a schematic flowchart illustrating a method for generating a video script according to an embodiment 5 of the disclosure.

As shown in FIG. 5, the method for generating a video script may include the following steps 501 to 505.

At step 501: a plurality of human body features corresponding to the target video are determined by performing human body recognition on each frame in the target video.

It should be understood that since a same character may appear in a plurality of frames, among the plurality of human body features obtained by performing the human body recognition on each frame in the target video, similar human body features may exist. The similar human body features may originate from the same character. For determining feature information corresponding to the character, excessive similar human body features are redundant and may slow down the progress of generating the character library.

At step 502: a plurality of voiceprint features corresponding to the target video are determined by performing the voiceprint extraction on the target video.

It should be understood that since a plurality of speaking characters may appear in the target video, and a speaking character may appear in different video segments of the target video, among the plurality of voiceprint features obtained by performing the voiceprint extraction on the target video, similar voiceprint features may exist. The similar voiceprint features may originate from a same speaking character. For determining the feature information corresponding to the character, excessive similar voiceprint features are redundant and may affect the progress of generating the character library.

At step 503: at least one voiceprint feature category is obtained by clustering the plurality of voiceprint features corresponding to the target video, and at least one human body feature category is obtained by clustering the plurality of human body features corresponding to the target video.

It should be noted that the voiceprint feature categories are used to identify corresponding characters, and the human body feature categories are also used to identify corresponding characters.

For example, assuming the plurality of voiceprint features corresponding to the target video are voiceprint feature a, voiceprint feature b, and voiceprint feature c, respectively. The voiceprint feature a and the voiceprint feature b are similar. Then, the voiceprint feature a, the voiceprint feature b, and the voiceprint feature c are clustered, a voiceprint feature category AB is obtained by clustering the voiceprint feature a and the voiceprint feature b, and a voiceprint feature category C is obtained by clustering the voiceprint feature c. The voiceprint feature category AB indicates a character AB corresponding to the voiceprint feature a and the voiceprint feature b, and the voiceprint feature category C indicates a character C corresponding to the voiceprint feature c.

For example, assuming the plurality of human body features corresponding to the target video are human body feature a, human body feature b, human body feature c, and human body feature d, respectively. The human body feature c and the human body feature d are similar. Then, the human body feature a, the human body feature b, the human body feature c, and the human body feature d are clustered, human body feature category A is obtained by clustering the human body feature a; human body feature category B is obtained by clustering the human body feature b; and human body feature category CD is obtained by clustering the human body feature c and the human body feature d.

At step 504: based on voiceprint features belonging to a same voiceprint feature category and human body features belonging to a same human body feature category, feature information corresponding to each character is determined.

To accurately obtain the feature information corresponding to each character, as a possible implementation manner, feature information of a corresponding character is determined based on a voiceprint feature category and a human body feature category belonging to the same character among the voiceprint features and the human body features.

For example, a speech segment from which voiceprint features in each voiceprint feature category originate is determined, and a frame from which human body features in each human body feature category originate is determined; based on a co-appearance relationship between the speech segment and the frame, the voiceprint feature category and the human body feature category belonging to the same character are determined; and based on the voiceprint feature category and the human body feature category belonging to the same character, feature information of the corresponding character is determined.

In the embodiment, a voiceprint feature at a cluster center in the voiceprint feature category belonging to the same character, and a human body feature at a cluster center in the human body feature category belonging to the same character, are determined as the feature information of a corresponding character.

It should be noted that a specific method for determining whether a voiceprint feature is at the cluster center in the voiceprint feature category, and a specific method for determining whether a human body feature is at the cluster center in the human body feature category, may be determined based on existing related technologies, which are not repeated in this embodiment.

At step 505: based on the feature information corresponding to each character, the character library is determined.

It should be understood that the target video may also have introduction text information of characters. Generally, the introduction text information usually appears in a frame where a character first appears in the target video. For example, when character A first appears in the target video, a name of the character A may be annotated within the frame where the character A is located. Then, the name of the character A may serve as introduction text information of the character A. Thus, to enrich data stored for each character in the character library, introduction text information of each character may also be stored in the character library.

In the embodiment, for any character, a first appearance frame ranked first is determined from a plurality of frames associated with the character; the introduction text information corresponding to the character is determined by performing text recognition on the first appearance frame; the introduction text information is stored in the character library.

In the method for generating a video script provided by the disclosure, the plurality of human body features corresponding to the target video are determined by performing the human body recognition on each frame in the target video; the plurality of voiceprint features corresponding to the target video are determined by performing the voiceprint extraction on the target video; at least one voiceprint feature category is obtained by clustering the plurality of voiceprint features corresponding to the target video, and at least one human body feature category is obtained by clustering the plurality of human body features corresponding to the target video; based on voiceprint features belonging to a same voiceprint feature category and human body features belonging to a same human body feature category, the feature information corresponding to each character is determined; and based on the feature information corresponding to each character, the character library is determined. Thus, based on the voiceprint feature categories and human body feature categories extracted and clustered from the target video, the voiceprint features belonging to the same voiceprint feature category and the human body features belonging to the same human body feature category are determined, and the character library is generated. Based on the pre-generated character library, it is unnecessary to repeatedly match feature information to be matched obtained from the human body feature of the speaker and the voiceprint feature of the speaker with the plurality of human body features corresponding to the target video and the plurality of voiceprint features corresponding to the target video to determine a target character in subsequent steps, which facilitates rapid and accurate determination of the target character in subsequent steps.

Corresponding to the method for generating a video script provided in the above embodiments shown in FIG. 1 to FIG. 5, the disclosure also provides an apparatus for generating a video script. Since the apparatus for generating a video script provided in the embodiments of the disclosure corresponds to the method for generating a video script provided in the above embodiments shown in FIG. 1 to FIG. 5, the implementations of the method for generating a video script are also applicable to the apparatus for generating a video script provided in the embodiments of the disclosure, and are not described in detail in the embodiments of the disclosure.

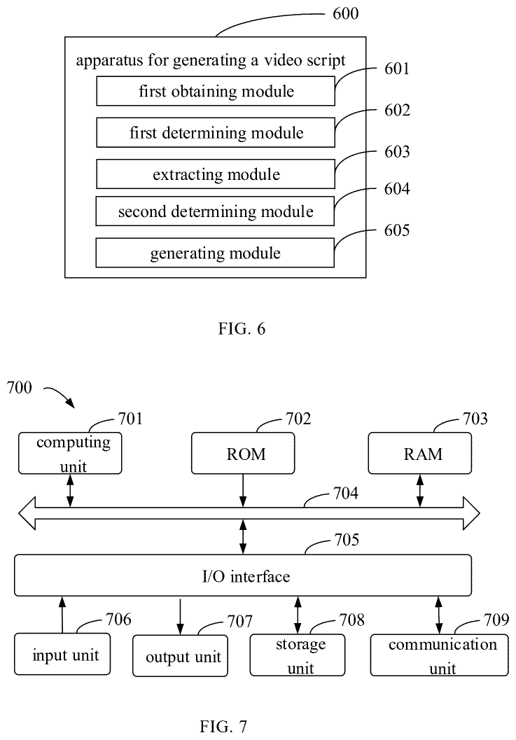

FIG. 6 is a block diagram illustrating an apparatus for generating a video script according to an embodiment 6 of the disclosure.

As shown in FIG. 6, the apparatus 600 for generating a video script may include: a first obtaining module 601, a first determining module 602, an extracting module 603, a second determining module 604, and a generating module 605.

The first obtaining module 601 is configured to obtain a target video.

The first determining module 602 is configured to obtain corresponding dialogue text information by performing speech recognition on speech segments in the target video.

The extracting module 603 is configured to extract a human body feature of a speaker from a frame associated with the speech segments in the target video, and extract a voiceprint feature of the speaker from the speech segments.

The second determining module 604 is configured to determine target feature information matching at least one of the human body feature of the speaker or the voiceprint feature of the speaker from a character library corresponding to the target video, and determine a target character corresponding to the target feature information in the character library.

The generating module 605 is configured to generate a video script for the target video based on the target character and the dialogue text information.

In a possible implementation of the disclosure, the extracting module 603 is specifically configured to:
for any speech segment in the target video, determine the voiceprint feature of the speaker by performing voiceprint extraction on the speech segment;
determine a first frame from a plurality of frames associated with the speech segment, in which a human body action in the first frame satisfies a predetermined requirement for the speaker; and
obtain the human body feature of the speaker by performing image feature extraction on the first frame.

In a possible implementation of the disclosure, the extracting module 603 is specifically configured to:
determine frames synchronously displayed with the speech segment as the plurality of frames associated with the speech segment;
obtain a human body region within each of the plurality of frames by performing object recognition thereon, and obtain the human body action by performing action recognition on the human body region; and
determine the first frame satisfying the predetermined requirement from the plurality of frames based on a human body action recognized in each frame.

In a possible implementation of the disclosure, the extracting module 603 is specifically configured to:
obtain the human body feature of the speaker by performing the image feature extraction on a target human body region within the first frame, in which the target human body region is a human body region in which the human body action satisfies the predetermined requirement.

In a possible implementation of the disclosure, the extracting module 603 is specifically configured to:
perform human body key point recognition on the human body region; and
determine the human body action based on a positional relationship among a plurality of recognized human body key points.

In a possible implementation of the disclosure, the second determining module 604 is specifically configured to:
obtain feature information to be matched from the human body feature of the speaker and the voiceprint feature of the speaker;
determine a similarity between each piece of feature information in a feature information set and the feature information to be matched, in which the feature information set is included in the character library and includes feature information corresponding to each character in the character library; and
determine, based on the similarity, the target feature information whose similarity exceeds a similarity threshold from the feature information set, and determine the target character corresponding to the target feature information in the character library.

In a possible implementation of the disclosure, the generating module 605 is specifically configured to:
determine, based on a speech segment where the target character is located and a speech segment where the dialogue text information is located, the target character and dialogue text information originating from a same speech segment; and
obtain, based on an appearance order of each speech segment in the target video, the video script by arranging a target character and dialogue text information of each speech segment in order.

In a possible implementation of the disclosure, the generating module 605 is specifically configured to:
perform background recognition on a silent segment and an adjacent speech segment between silent segments;
in a case that the silent segment has a background switch relative to the adjacent speech segment, obtain background description information of the silent segment by performing semantic recognition on a background of the silent segment; and
insert, based on an appearance order of the silent segment in the target video, the background description information into the video script.

In a possible implementation of the disclosure, the generating module 605 is specifically configured to:
obtain introduction text information corresponding to the target character by querying the character library based on the target character, in which the character library includes introduction text information corresponding to each character; and
supplement, based on a position of the dialogue text information of the target character in the video script, the introduction text information to the video script.

In a possible implementation of the disclosure, the apparatus further includes a character library module, specifically configured to:
determine a plurality of human body features corresponding to the target video by performing human body recognition on each frame in the target video;
determine a plurality of voiceprint features corresponding to the target video by performing the voiceprint extraction on the target video;
obtain at least one voiceprint feature category by clustering the plurality of voiceprint features corresponding to the target video, and obtain at least one human body feature category by clustering the plurality of human body features corresponding to the target video;
determine, based on voiceprint features belonging to a same voiceprint feature category and human body features belonging to a same human body feature category, the feature information corresponding to each character; and
determine, based on the feature information corresponding to each character, the character library.

In a possible implementation of the disclosure, the character library module is specifically configured to:
determine a speech segment from which voiceprint features in each voiceprint feature category originate, and determine a frame from which human body features in each human body feature category originate;
determine, based on a co-appearance relationship between the speech segment and the frame, a voiceprint feature category and a human body feature category belonging to a same character; and
determine, based on the voiceprint feature category and the human body feature category belonging to the same character, feature information of a corresponding character.

In a possible implementation of the disclosure, the character library module is specifically configured to:
determine a voiceprint feature at a cluster center in the voiceprint feature category belonging to the same character, and a human body feature at a cluster center in the human body feature category belonging to the same character, as the feature information of the corresponding character.

In a possible implementation of the disclosure, the character library module is specifically configured to:
for any character, determine a first appearance frame ranked first from a plurality of frames associated with the character;
determine introduction text information corresponding to the character by performing text recognition on the first appearance frame; and
store the introduction text information in the character library.

In summary, the apparatus for generating a video script provided by the disclosure obtains the target video and obtains the corresponding dialogue text information by performing the speech recognition on the speech segments in the target video. The human body feature of the speaker is extracted from the frame associated with the speech segments in the target video, and the voiceprint feature of the speaker is extracted from the speech segments. The target feature information matching at least one of the human body feature of the speaker or the voiceprint feature of the speaker is determined from the character library corresponding to the target video, and the target character corresponding to the target feature information in the character library is determined. The video script for the target video is generated based on the target character and the dialogue text information. Thus, by performing the image feature extraction on each frame of the target video, not only the human body feature of the speaker is considered, but also the voiceprint feature of the speaker is considered. Based on the character library, both the human body feature and the voiceprint feature are comprehensively used to identify the target character appearing in the video, facilitating accurate identification of characters appearing in the video. Furthermore, during the process of generating the script, starting from the perspective of the target character in the video, focusing on the dialogue text information described by the target character enables the generated video script to accurately reflect the content of the video, helps deepen the understanding of the video, and thus facilitates various subsequent applications based on the generated video script.

To implement the above embodiments, the disclosure also provides an electronic device. The electronic device includes at least one processor; and a memory communicatively connected to the at least one processor and storing instructions executable by the at least one processor; in which when the instructions are executed by the at least one processor, the at least one processor is caused to perform the method for generating a video script provided in any embodiment of the disclosure.

To implement the above embodiments, the disclosure also provides a non-transitory computer readable storage medium, which stores computer instructions. The computer instructions are used to enable a computer to perform the method for generating a video script provided in any embodiment of the disclosure.

To implement the above embodiments, the disclosure also provides a computer program product. The computer program product includes a computer program which when executed by a processor, steps of the method for generating a video script provided in any embodiment of the disclosure is implemented.

FIG. 7 is a block diagram illustrating an electronic device 700 according to an embodiment of the disclosure. The electronic device is intended to represent various types of digital computers, such as laptop computers, desktop computers, workstations, personal digital assistants, servers, blade servers, mainframe computers, and other suitable computers. The electronic device may also represent various types of mobile devices, such as personal digital assistants, cellular phones, smart phones, wearable devices, and other similar computing devices. The components shown herein, their connections and relationships, and their functions are merely examples, which are not intended to limit the implementations of the disclosure described and/or required herein.

As shown in FIG. 7, the device 700 includes a computing unit 701, configured to execute various appropriate actions and processes based on a computer program stored in a read-only memory (ROM) 702 or a computer program loaded from a storage unit 708 to a random access memory (RAM) 703. In the RAM 703, various programs and data required for the device 700 may be stored. The computing unit 701, the ROM 702 and the RAM 703 may be connected with each other by a bus 704. An input/output (I/O) interface 705 is also connected to the bus 704.

The plurality of components in the device 700 are connected to the I/O interface 705, which include: an input unit 706, for example, a keyboard, a mouse; an output unit 707, for example, various types of displays, speakers; the storage unit 708, for example, a magnetic disk, an optical disk; and a communication unit 709, for example, a network card, a modem, a wireless transceiver. The communication unit 709 allows the device 700 to exchange information/data through a computer network such as Internet and/or various types of telecommunication networks with other devices.

The computing unit 701 may be various types of general and/or dedicated processing components with processing and computing abilities. Some examples of a computing unit 701 include but not limited to a central processing unit (CPU), a graphics processing unit (GPU), various dedicated artificial intelligence (AI) computing chips, various computing units on which a machine learning model algorithm is running, a digital signal processor (DSP), and any appropriate processor, controller, microcontroller, etc. The computing unit 701 executes various methods and processes as described above, for example, a method for generating a video script. For example, in some embodiments, the method for generating a video script may be further implemented as a computer software program, which is tangibly contained in a machine readable medium, such as the storage unit 708. In some embodiments, a part or all of the computer program may be loaded and/or installed on the device 700 via the ROM 702 and/or the communication unit 709. When the computer program is loaded on the RAM 703 and executed by the computing unit 701, one or more steps in the method for generating a video script may be performed as described above. Optionally, in other embodiments, the computing unit 701 may be configured to perform the method for generating a video script in other appropriate ways (for example, via firmware).

Various implementations of the systems and techniques described above may be implemented in a digital electronic circuit system, an integrated circuit system, a field programmable gate array (FPGAs), an application specific integrated circuit (ASIC), an application specific standard product (ASSP), a system on chip (SOC), a complex programmable logic device (CPLD), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from a storage system, at least one input device and at least one output device, and transmitting the data and instructions to the storage system, the at least one input device and the at least one output device.

The program code configured to implement the method of the disclosure may be written in any combination of one or more programming languages. These program codes may be provided for processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on a machine, partly executed on the machine, partly executed on the machine and partly executed on a remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, RAMs, ROMs, electrically programmable read-only-memory (EPROM) or a flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a cathode ray tube (CRT) or a liquid crystal display (LCD) monitor) for displaying information to a user; and a keyboard and pointing device (such as a mouse or trackball) through which the user can provide input to the computer. Other kinds of devices may also be used to provide interaction with the user. For example, feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes backend components (for example, as a data server), or a computing system that includes middleware components (for example, an application server), or a computing system that includes frontend components (for example, a user computer with a graphical user interface or a web browser, via which the user can interact with the implementation of the systems and technologies described herein), or a computing system that includes any combination of such backend components, middleware components, or frontend components. The components of the system may be interconnected by any form or medium of digital data communication (e.g., a communication network). Examples of communication networks include: a local area network (LAN), a wide area network (WAN), the Internet, and a blockchain network.

The computer system may include a client and a server. The client and the server are generally far away from respective other and generally interact with respective other through a communication network. The relationship between the client and the server is generated by computer programs that run on the corresponding computers and have a client-server relationship with respective other. A server may be a cloud server, also known as a cloud computing server or a cloud host, is a host product in a cloud computing service system, to solve the shortcomings of large management difficulty and weak business expansibility existed in the traditional physical host and a “virtual private server” (VPS) service. The server further may be a server in a distributed system, or a server in combination with a blockchain.

It should be noted that AI is a discipline that studies enabling computers to simulate certain human cognitive processes and intelligent behaviors (e.g., learning, reasoning, thinking, planning, etc.), encompassing technologies at both the hardware level and the software level. AI hardware technologies generally include technologies such as sensors, dedicated AI chips, cloud computing, distributed storage, and big data processing. The AI software technologies primarily include several major domains: computer vision technology, speech recognition technology, natural language processing technology, and machine learning/deep learning, big data processing technology, and knowledge graph technology.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A method for generating a video script, comprising:
obtaining a target video;
obtaining dialogue text information by performing speech recognition on speech segments in the target video;
extracting a human body feature of a speaker from a frame associated with the speech segments in the target video, and extracting a voiceprint feature of the speaker from the speech segments;
determining target feature information matching at least one of the human body feature of the speaker or the voiceprint feature of the speaker from a character library corresponding to the target video, and determining a target character corresponding to the target feature information in the character library; and
generating the video script for the target video based on the target character and the dialogue text information.

2. The method according to claim 1, wherein extracting the human body feature of the speaker from the frame associated with the speech segments in the target video, and extracting the voiceprint feature of the speaker from the speech segments comprises:
for any speech segment in the target video, determining the voiceprint feature of the speaker by performing voiceprint extraction on the speech segment;
determining a first frame from a plurality of frames associated with the speech segment, wherein a human body action in the first frame satisfies a predetermined requirement for the speaker; and
obtaining the human body feature of the speaker by performing image feature extraction on the first frame.

3. The method according to claim 2, wherein determining the first frame from the plurality of frames associated with the speech segment comprises:
determining frames synchronously displayed with the speech segment as the plurality of frames associated with the speech segment;
obtaining a human body region within each of the plurality of frames by performing object recognition thereon, and obtaining the human body action by performing action recognition on the human body region; and
determining the first frame satisfying the predetermined requirement from the plurality of frames based on the human body action recognized within each frame.

4. The method according to claim 3, wherein obtaining the human body feature of the speaker by performing the image feature extraction on the first frame comprises:
obtaining the human body feature of the speaker by performing the image feature extraction on a target human body region within the first frame, wherein the target human body region is a human body region in which the human body action satisfies the predetermined requirement.

5. The method according to claim 2, wherein obtaining the human body action by performing the action recognition on the human body region comprises:
performing human body key point recognition on the human body region; and
determining the human body action based on a positional relationship among a plurality of recognized human body key points.

6. The method according to claim 1, wherein determining the target feature information matching at least one of the human body feature of the speaker or the voiceprint feature of the speaker from the character library corresponding to the target video, and determining the target character corresponding to the target feature information in the character library comprises:
obtaining feature information to be matched from the human body feature of the speaker and the voiceprint feature of the speaker;
determining a similarity between each piece of feature information in a feature information set and the feature information to be matched, wherein the feature information set is comprised in the character library and comprises the feature information corresponding to each character in the character library; and
determining, based on the similarity, the target feature information whose similarity exceeds a similarity threshold from the feature information set, and determining the target character corresponding to the target feature information in the character library.

7. The method according to claim 1, wherein generating the video script for the target video based on the target character and the dialogue text information comprises:
determining, based on a speech segment where the target character is located and a speech segment where the dialogue text information is located, a target character and dialogue text information originating from a same speech segment; and
obtaining the video script by arranging a target character and dialogue text information of each speech segment in order based on an appearance order of each speech segment in the target video.

8. The method according to claim 7, wherein the target video further comprises a silent segment, and the method further comprises:
performing background recognition on the silent segment and an adjacent speech segment for the silent segment;
in a case that the silent segment has a background switch relative to the adjacent speech segment, obtaining background description information of the silent segment by performing semantic recognition on a background of the silent segment; and
inserting, based on an appearance order of the silent segment in the target video, the background description information into the video script.

9. The method according to claim 8, further comprising:
obtaining introduction text information corresponding to the target character by querying the character library based on the target character, wherein the character library comprises introduction text information corresponding to each character; and
supplementing, based on a position of the dialogue text information of the target character in the video script, the introduction text information of the target character to the video script.

10. The method according to claim 1, wherein the character library is generated by:
determining a plurality of human body features corresponding to the target video by performing human body recognition on each frame in the target video;
determining a plurality of voiceprint features corresponding to the target video by performing the voiceprint extraction on the target video;
obtaining at least one voiceprint feature category by clustering the plurality of voiceprint features corresponding to the target video, and obtaining at least one human body feature category by clustering the plurality of human body features corresponding to the target video;
determining, based on voiceprint features belonging to a same voiceprint feature category and human body features belonging to a same human body feature category, feature information corresponding to each character; and
determining, based on the feature information corresponding to each character, the character library.

11. The method according to claim 10, wherein determining, based on the voiceprint features belonging to the same voiceprint feature category and the human body features belonging to the same human body feature category, the feature information corresponding to each character comprises:
determining a speech segment from which voiceprint features in each voiceprint feature category originate, and determining a frame from which human body features in each human body feature category originate;
determining, based on a co-appearance relationship between the speech segment and the frame, a voiceprint feature category and a human body feature category belonging to a same character; and
determining, based on the voiceprint feature category and the human body feature category belonging to the same character, feature information of a corresponding character.

12. The method according to claim 11, wherein determining, based on the voiceprint feature category and the human body feature category belonging to the same character, the feature information of the corresponding character comprises:
determining a voiceprint feature at a cluster center in the voiceprint feature category belonging to the same character, and a human body feature at a cluster center in the human body feature category belonging to the same character, as the feature information of the corresponding character.

13. The method according to claim 10, further comprising:
for any character, determining a first appearance frame ranked first from a plurality of frames associated with the character;
determining introduction text information corresponding to the character by performing text recognition on the first appearance frame; and
storing the introduction text information in the character library.

14. An electronic device, comprising: a processor and a memory with executable program codes stored thereon;
wherein the processor is configured to:
obtain a target video;
obtain dialogue text information by performing speech recognition on speech segments in the target video;
extract a human body feature of a speaker from a frame associated with the speech segments in the target video, and extract a voiceprint feature of the speaker from the speech segments;
determine target feature information matching at least one of the human body feature of the speaker or the voiceprint feature of the speaker from a character library corresponding to the target video, and determine a target character corresponding to the target feature information in the character library; and
generate the video script for the target video based on the target character and the dialogue text information.

15. The electronic device according to claim 14, wherein the processor is configured to:
for any speech segment in the target video, determine the voiceprint feature of the speaker by performing voiceprint extraction on the speech segment;
determine a first frame from a plurality of frames associated with the speech segment, wherein a human body action in the first frame satisfies a predetermined requirement for the speaker; and
obtain the human body feature of the speaker by performing image feature extraction on the first frame.

16. The electronic device according to claim 14, wherein the processor is configured to:
obtain feature information to be matched from the human body feature of the speaker and the voiceprint feature of the speaker;
determine a similarity between each piece of feature information in a feature information set and the feature information to be matched, wherein the feature information set is comprised in the character library and comprises the feature information corresponding to each character in the character library; and
based on the similarity, determine the target feature information whose similarity exceeds a similarity threshold from the feature information set, and determine the target character corresponding to the target feature information in the character library.

17. The electronic device according to claim 14, wherein the processor is configured to:
determine, based on a speech segment where the target character is located and a speech segment where the dialogue text information is located, a target character and dialogue text information originating from a same speech segment; and
obtain the video script by arranging a target character and dialogue text information of each speech segment in order based on an appearance order of each speech segment in the target video.

18. The electronic device according to claim 17, wherein the target video further comprises a silent segment, and the processor is configured to:
perform background recognition on the silent segment and an adjacent speech segment for the silent segment;
in a case that the silent segment has a background switch relative to the adjacent speech segment, obtain background description information of the silent segment by performing semantic recognition on a background of the silent segment; and
insert, based on an appearance order of the silent segment in the target video, the background description information into the video script.

19. The electronic device according to claim 18, wherein the processor is configured to:
obtain introduction text information corresponding to the target character by querying the character library based on the target character, wherein the character library comprises introduction text information corresponding to each character; and
supplement, based on a position of the dialogue text information of the target character in the video script, the introduction text information of the target character to the video script.

20. A non-transitory computer-readable storage medium having stored a computer program that, when executed by a processor, implements the method for generating a video script comprising:
obtaining a target video;
obtaining dialogue text information by performing speech recognition on speech segments in the target video;
extracting a human body feature of a speaker from a frame associated with the speech segments in the target video, and extracting a voiceprint feature of the speaker from the speech segments;
determining target feature information matching at least one of the human body feature of the speaker or the voiceprint feature of the speaker from a character library corresponding to the target video, and determining a target character corresponding to the target feature information in the character library; and
generating the video script for the target video based on the target character and the dialogue text information.
